(19) United States
(12) Patent Application Publication
(10) Pub. No.: US 2011/0162939 A1
(43) Pub. Date: Jul. 7, 2011

(54) BANKNOTE HANDLING MACHINE

(76) Inventor: Kazuhiro Doi, Hyogo-ken (JP)

(21) Appl. No.: 12/998,107

(22) PCT Filed: Sep. 19, 2008
(86) PCT No.: PCT/JP2008/066988

§ 371 Date: Mar. 17, 2011

(51) Int. Cl. G07F 7/04

(52) U.S. Cl. 194/206

(57) ABSTRACT

A banknote handling machine (1) comprises a first banknote handling apparatus (2) including a recognition unit (6) configured for recognizing the banknotes taken in by the take-in unit (4), and a plurality of stackers (13, 14, 15, 16) configured for stacking therein the banknotes respectively recognized by the recognition unit (6), a second banknote handling apparatus (3) connected with the first banknote handling apparatus (2), configured for receiving the banknotes recognized by the recognition unit (6) of the first banknote handling apparatus (2) and including a plurality of stacker (32, 33, 34, 35) configured for stacking therein the banknotes fed from the first banknote handling apparatus (2), and a control unit (70) configured for controlling the first banknote handling apparatus (2) and second banknote handling apparatus (3). The control unit (70) controls the first banknote handling apparatus (2) and second banknote handling apparatus (3) to assign the banknote handling apparatuses, to which the banknotes of the first country and the banknotes of another country than the first country are to be respectively transported, to the first banknote handling apparatus (2) or second banknote handling apparatus (3).

### FIELD OF THE INVENTION

The present invention relates to a banknote handling machine configured for handling banknotes of a plurality of denominations of a plurality of countries (e.g., such banknotes include the banknotes of a first country and the banknotes of another country (or other countries) than the first country). As used herein, the concept of the “country” includes a “federation of states or nations (e.g., the European Union (EU) or the like)”. Specifically, as the banknotes of the plurality of countries, the Japanese yen banknotes, US dollar banknotes, Chinese yuan banknotes, EURO banknotes and the like can be mentioned.

### BACKGROUND ART

In the past, the banknote handling apparatus, as disclosed in JP2005-165806A, has been known, which is configured for sorting the banknotes of the plurality of denominations into ones to be respectively stored in a plurality of stackers. This banknote handling apparatus disclosed in the JP2006-165806A is configured for taking therein the plurality of banknotes respectively placed on a hopper in a stacked condition, one by one, from the lowermost banknote, and then transporting them in a casing, while recognizing the banknotes, respectively taken and transported in the casing, by a recognition unit, about the denomination or the like thereof. Further, based on the recognition result on the banknotes respectively recognized by the recognition unit, this banknote handling apparatus is operable to sort the banknotes into the ones to be respectively stored in each of the plurality of (e.g., three) stackers.

More specifically, the banknote handling apparatus disclosed in the above JP2005-165806A is configured, such that an operator assigns any given denomination of money to each stacker, except for a certain one stacker, among the plurality of stackers. Therefore, if the denomination of the banknote recognized by the recognition unit corresponds to the denomination assigned to any one of the stackers, such a banknote will be stacked in this stacker. Meanwhile, if the denomination of the banknotes respectively recognized by the recognition unit does not correspond to the denomination assigned to any one of the stackers, such banknotes will be stacked, in a mixed state, in the certain one stacker.

Thereafter, when any one of the stackers is completely filled with the banknotes, or when a counting process for the banknotes is ended, the handling operation for the banknotes is stopped, and then the assignment setting of the denomination to each stacker is cleared.

Thereafter, the operator removes the banknotes from each stacker to which a certain denomination is assigned, while placing again the banknotes present in the mixed state in the certain one stacker, on the hopper, in the stacked condition. Subsequently, the operator assigns again the denomination of such banknotes to each stacker. Then, the banknotes placed on the hopper are respectively taken in the casing, and recognized by the recognition unit about the denomination or the like thereof. If the denomination of the banknote recognized by the recognition unit corresponds to the denomination assigned to any one of the stackers, such banknotes will be stacked in this stacker. Meanwhile, if the denomination of the banknote recognized by the recognition unit does not correspond to the denomination assigned to any one of the stackers, such banknotes will be stacked, again, in the mixed state, in the certain one stacker. In this manner, with several repetitions of such handling operations, the banknotes can be eventually sorted for each denomination thereof.

### DISCLOSURE OF THE INVENTION

It is true that the banknote handling apparatus disclosed in the above 3P2005-165806A can sort the banknotes, for each denomination thereof, by repeating such handling operations for the banknotes, several times, as described above. However, in this case, the number of times the banknotes are handled is considerably large. More specifically, the banknote handling apparatus disclosed in the above JP2005-165806A includes three stackers, and one stacker is provided as the aforementioned certain one stacker, while the other two stackers are provided as ones, to which the denominations of the banknotes are respectively assigned. Therefore, in the case the banknotes of, for example, six denominations are handled by this banknote handling apparatus, only the banknotes of two denominations can be sorted in one handling operation. Thus, for all of the denominations of such banknotes, the handling operation should be performed three times.

Additionally, in the case the banknotes are handled by the banknote handling apparatus installed in a national border area or the like, the banknotes of a plurality of the countries are likely to be in the mixed state. Therefore, it is necessary to sort such mixed banknotes, for each denomination of the respective countries, leading to further increase of the number of times the banknotes should be handled. More specifically, in the case the banknotes are handled by the banknote handling apparatus installed in the national border area, it is necessary that such banknotes should be first sorted into the banknotes of the first country and the banknotes of another country than the first country. Thereafter, such sorted banknotes of each country should be further sorted by the banknote handling apparatus exclusively used for the country. Therefore, such banknotes should be handled so many times.

The present invention was made in light of the above circumstances. Therefore, it is an object of this invention to provide a new banknote handling machine, which can successfully prevent the number of times the banknotes should be handled from being unduly increased, even in the case of handling the banknotes of the plurality of denominations of the plurality of countries.

A banknote handling machine according to the present invention is configured for handling banknotes of a plurality of denominations of a plurality of countries, such banknotes including the banknotes of a first country and the banknotes of another country than the first country, and the banknote handling machine includes: a first banknote handling apparatus including a take-in unit configured for taking in the banknotes, a recognition unit configured for recognizing the banknotes taken in by the take-in unit, and a stacker configured for stacking therein the banknotes respectively recognized by the recognition unit; a second banknote handling apparatus connected with the first banknote handling apparatus, configured for receiving the banknotes recognized by the recognition unit of the first banknote handling apparatus and including another stacker configured for stacking therein the banknotes fed from the first banknote handling apparatus; and a control unit configured for controlling the first banknote handling apparatus and second banknote handling apparatus to assign the banknote handling apparatuses, to which the banknotes of the first country and the banknotes of another country than the first country are to be respectively transported, to the first banknote handling apparatus or second banknote handling apparatus.

According to the banknote handling machine of the present invention, the second banknote handling apparatus is connected with the first banknote handling apparatus, such that the banknotes respectively recognized by the recognition unit of the first banknote handling apparatus can be fed to the second banknote handling apparatus. Then, due to the control unit, the banknotes of the first country and the banknotes of another country than the first country can be separated from one another and fed to the first banknote handling apparatus and second banknote handling apparatus, respectively. Namely, in the case of handling the banknotes of the plurality of denominations of the plurality of countries, such banknotes are first sorted, for each country, into the banknotes to be transported to the first banknote handling apparatus and the banknotes to be transported to the second banknote handling apparatus. Therefore, as compared with the banknote handling machine including the plurality of stackers arranged in parallel relative to one another, the number of times the banknotes should be handled can be substantially lessened.

In the banknote handling machine of the present invention, it is preferred that when the banknote recognized by the recognition unit of the first banknote handling apparatus is the banknote of the first country, the control unit controls such that such a banknote is stacked in the stacker of the second banknote handling apparatus, while when the banknote recognized by the recognition unit of the first banknote handling apparatus is the banknote of another country than the first country, the control unit controls such that such a banknote is stacked in the stacker of the first banknote handling apparatus.

In the banknote handling machine of the present invention, it is preferred that a plurality of stackers are provided to the first banknote handling apparatus and configured such that the banknotes are stacked in each stacker, for each denomination thereof.

In the banknote handling machine of the present invention, it is preferred that a plurality of stackers are provided to the second banknote handling apparatus and configured such that the banknotes are stacked in each stacker, for each denomination thereof.

In the banknote handling machine of the present invention, it is preferred that the second banknote handling apparatus includes a bundling unit configured for bundling the banknotes stacked in the stacker of the second banknote handling apparatus, with a bundling paper, so as to prepare bundled banknotes.

In this case, it is further preferred that in a first handling operation, when the banknote recognized by the recognition unit of the first banknote handling apparatus is the banknote of the first country, the control unit controls such that such a banknote is stacked in the stacker of the second banknote handling apparatus, while when the banknote recognized by the recognition unit of the first banknote handling apparatus is the banknote of another country than the first country, the control unit controls such that such a banknote is stacked in the stacker of the first banknote handling apparatus, and then controls the bundling unit to bundle the banknotes of the first country stacked in the stacker of the second banknote handling apparatus, with the bundling paper, thereby allowing such bundle banknotes of the first country to be taken out from the second banknote handling apparatus, and in a second handling operation following the first handling operation, when the banknote recognized by the recognition unit of the first banknote handling apparatus is the banknote of another country than the first country, the control unit controls such that such a banknote is stacked in the stacker of the second banknote handling apparatus, and then controls the bundling unit to bundle the banknotes of another country than the first country stacked in the stacker of the second banknote handling apparatus, with the bundling paper, thereby allowing such bundled banknotes of another country than the first country to be taken out from the second banknote handling apparatus.

In the banknote handling machine of the present invention, it is preferred that the banknote handling machine further includes a destination designation unit configured for designating, in advance, each of the banknote handling apparatuses, to which the banknotes of the first country and the banknotes of another country than the first country are to be respectively transported, and the control unit controls such that the banknotes of the first country and banknotes of another country than the first country are respectively stacked in the stacker of each banknote handling apparatus designated by the destination designation unit, based on the recognition result of the banknotes respectively recognized by the recognition unit of the first banknote handling apparatus.

Alternatively, it is preferred that the banknote handling machine further includes a destination designation unit configured for designating, in advance, each of the banknote handling apparatuses, to which the banknotes of the first country and the banknotes of another country than the first country are to be respectively transported, a preferential-country designation unit configured for designating, in advance, which of the banknotes of the first country and the banknotes of another country than the first country are to be preferentially handled; and a memory configured for storing therein the number of the denominations of money, for each country, and when the number of the denominations of money stored in the memory is greater than the number of the stackers of one banknote handling apparatus designated by the destination designation unit, in regard to the banknotes of the first country or banknotes of another country than the first country designated by the preferential-country designation unit, the control unit assigns the stacker of the other banknote handling apparatus to stack therein the banknotes, the denomination of which is not assigned to the stacker of the one banknote handling apparatus designated by the destination designation unit.

In the banknote handling machine of the present invention, it is preferred that the banknote handling machine is configured for handling the banknotes of three or more countries, a plurality of stackers are provided to the first banknote handling apparatus and second banknote handling apparatus, respectively, and when the banknote recognized by the recognition unit of the first banknote handling apparatus is the banknote of the first country, the control unit controls such that such a banknote is stacked in each stacker of the second banknote handling apparatus, for each denomination thereof, while when the banknote recognized by the recognition unit of the first banknote handling apparatus is not the banknote of the first country or the banknote of a second country, the control unit controls such that such a banknote is stacked in a certain one of the stackers of the first banknote handling apparatus, in a mixed state, and while when the banknote recognized by the recognition unit of the first banknote handling apparatus is the banknote of the second country, the control unit controls such that such a banknote is stacked in each stacker, except for the certain one stacker, of the first banknote handling apparatus, for each denomination thereof.

### BRIEF DESCRIPTION OF THE DRAWINGS

FIG. 1 is a diagram showing general construction of a banknote handling machine related to one embodiment of the present invention.

FIG. 2 is a diagram illustrating detailed construction of a first banknote handling apparatus of the banknote handling machine shown in FIG. 1.

FIG. 3 is a diagram illustrating detailed construction of a second banknote handling apparatus of the banknote handling machine shown in FIG. 1.

FIG. 4 is a block diagram of a control system provided for the banknote handling machine shown in FIG. 1.

### DETAILED DESCRIPTION OF THE INVENTION

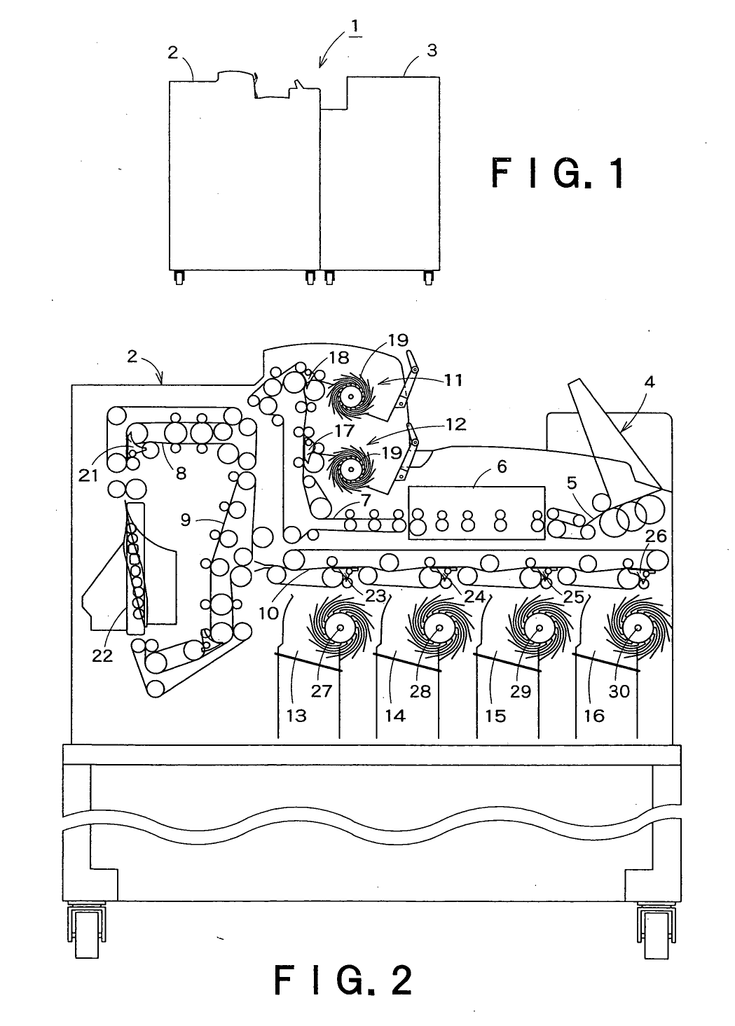

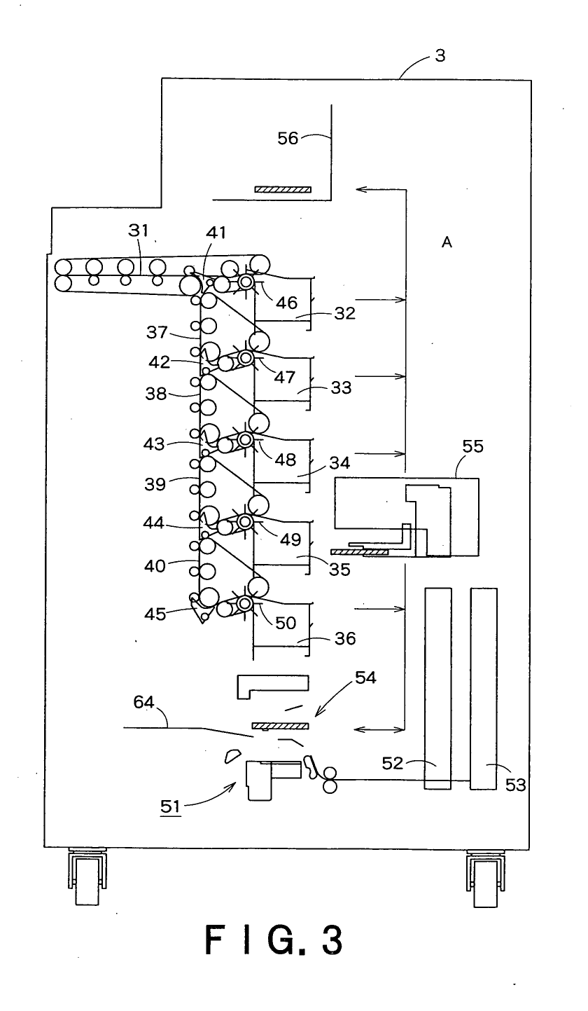

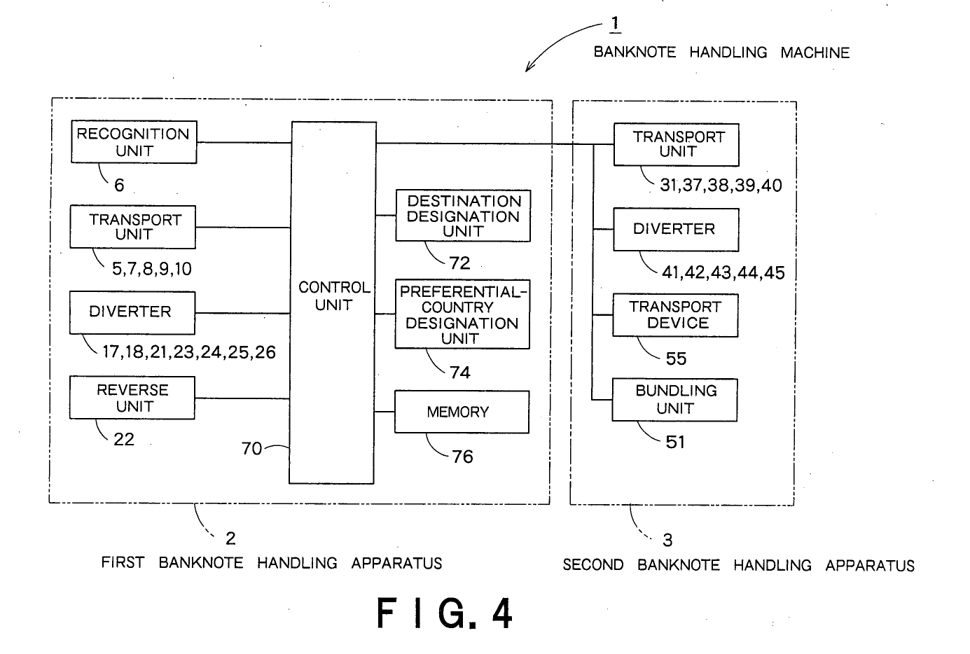

Hereinafter, one exemplary embodiment of the present invention will be described with reference to the drawings. FIGS. 1 through 4 are provided for respectively illustrating the banknote handling machine related to the embodiment of this invention. Of these drawings, FIG. 1 shows the general construction of the banknote handling machine of this embodiment. FIG. 2 shows one detailed construction of the first banknote handling apparatus related to the banknote handling machine shown in FIG. 1. FIG. 3 shows one detailed construction of the second banknote handling apparatus related to the banknote handling machine shown in FIG. 1. FIG. 4 illustrates one exemplary control system provided for the banknote handling machine shown in FIG. 1.

The banknote handling machine 1 of this embodiment is designed for handling the banknotes of the plurality of denominations of the plurality of countries, such banknotes including the banknotes of a first country and the banknotes of another country than the first country. As shown in FIG. 1, the banknote handling machine 1 includes the first banknote handling apparatus 2 and the second banknote handling apparatus 3, respectively arranged in parallel relative to each other. Further, as shown in FIG. 1, each of the first banknote handling apparatus 2 and second banknote handling apparatus 3 is of a substantially rectangular parallelepiped shape, and these two banknote handling apparatuses 2, 3 are connected with each other.

First, referring to FIG. 2, the construction of the first banknote handling apparatus 2 will be described in detail.

As shown in FIG. 2, the first banknote handling apparatus 2 includes an take-in unit 4 configured for taking the banknotes into the first banknote handling apparatus 2. The take-in unit 4 includes a hopper configured for placing thereon a plurality of banknotes in the stacked condition, and a feeding mechanism configured for feeding the banknotes placed on the hopper, one by one, from the lowermost banknote, into the casing of the first banknote handling apparatus 2. In this embodiment, the banknotes, respectively fed into the casing by the feeding mechanism of the take-in unit 4, will be transported, one by one, by a transport unit 5. This transport unit 5 is provided with a recognition unit 6 configured for recognizing each banknote transported by the transport unit 5. The recognition unit 6 can serve to recognize each banknote about the denomination, fitness, authenticity, face/back or the like thereof. After recognized by the recognition unit 6, each banknote will be transported by another transport unit 7.

The transport unit 7 is provided with two diverters 17, 18, respectively arranged in series relative to each other. By switching such diverters 17, 18, the banknote that cannot be recognized by the recognition unit 6 and/or banknote that is recognized, as rejected banknote, by the recognition unit 6 can be stacked in each rejected banknote stacker 11, 12. As used herein, the “rejected banknote” means an unfit banknote (i.e., a considerably damaged banknote, such as a torn and/or stained banknote), a counterfeit banknote or the like. Such rejected banknotes are separated from the banknotes that can be recycled and reused, and then stacked in the rejected banknote stackers 11, 12, respectively. In each of the rejected banknote stackers 11, 12, a stacking wheel 19 or 20 is provided. Each of the stacking wheels 19, 20 can serve to receive and stack the rejected banknotes which are fed into the rejected banknote stacker 11 or 12, one by one.

Meanwhile, the banknotes other than the rejected banknotes are further transported to another transport unit 8 from the transport unit 7. This transport unit 8 is provided with a diverter 21. By switching this diverter 21, the banknotes can be transported, directly, to another transport unit 9 from the transport unit 8, or otherwise can be transported to the transport unit 9, via a reverse unit 22, from the transport unit 8. The reverse unit 22 is provided for reversing the face/back of each banknote. The transport unit 9 can serve to transport the respective banknotes (i.e., both of the banknotes directly fed thereto from the transport unit 8 and the banknotes fed thereto, via the reverse unit 22, from the transport unit 8) to another transport unit 10, while keeping the order of transportation of the respective banknotes by controlling the time required for each transportation and the timing of transportation.

The transport unit 10 is configured for transporting the banknotes in a substantially horizontal direction (or rightward in FIG. 2). For instance, four stackers 13, 14, 15, 16 are arranged, in parallel to one another, below the transport unit 10. The transport unit 10 is provided with diverters 23, 24, 25, 26, respectively arranged in series relative to one another. By switching such diverters 23, 24, 25, 26, the banknotes transported by the transport unit 10 can be stacked in any suitable one of the four stackers 13, 14, 15, 16. In the stackers 13, 14, 15, 16, stacking wheels 27, 28, 29, 30 are provided, respectively. Each of the stacking wheels 27, 28, 29, 30 can serve to receive and stack the banknotes which are fed into each corresponding stacker 13, 14, 15, 16, one by one. In addition, a right end of the transport unit 10 is connected to the second banknote handling apparatus 3. Namely, during the transportation of the banknotes by the transport unit 10, the banknotes that are not fed to any of the stackers 13, 14, 15, 16 will be fed to another transport unit 31 (which will be described later) of the second banknote handling apparatus 3 from the transport unit 10.

Now, referring to FIG. 3, the construction of the second banknote handling apparatus 3 will be described in detail.

As shown in FIG. 3, in the casing of the second banknote handling apparatus 3, a plurality of (e.g., five) stackers 32, 33, 34, 35, 36 are arranged, respectively, in the vertical direction. Further, transport units 37, 38, 39, 40 are provided, respectively, for stacking the banknotes in any of such five stackers 32, 33, 34, 35, 36.

In addition, in the casing of the second banknote handling apparatus 3, the transport unit 31 is provided for receiving the banknotes fed from the transport unit 10 of the first banknote handling apparatus 2. This transport unit 31 is provided with a diverter 41. By switching this diverter 41, the banknotes transported by the transport unit 31 can be stacked in the stacker 32, or otherwise can be further transported to the transport unit 37. Similarly, the transport unit 37 is provided with a diverter 42. By switching this diverter 42, the banknotes transported by the transport unit 37 can be stacked in the stacker 33, or otherwise can be further transported to the transport unit 38.

Further, the transport unit 38 is provided with a diverter 43. By switching this diverter 43, the banknotes transported by the transport unit 38 can be stacked in the stacker 34, or otherwise can be further transported to the transport unit 39. Similarly, the transport unit 39 is provided with a diverter 44. By switching this diverter 44, the banknotes transported by the transport unit 39 can be stacked in the stacker 35, or otherwise can be further transported to the transport unit 40. Further, the transport unit 40 is provided with a diverter 45 that is fixed in position. With the provision of this diverter 45, the banknotes transported by the transport unit 40 can be stacked in the stacker 36. For each of the transport units 31, 37, 38, 39, 40, each stacking wheel 46, 47, 48, 49 or 50 is provided at a point of an inlet of each corresponding stacker 32, 33, 34, 35, 36. Namely, each stacking wheel 46, 47, 48, 49, 50 is provided for properly beating a rear end portion of each banknote that is about to fall down, by its weight, into each stacker 32, 33, 34, 35, 36 from each corresponding transport unit 31, 37, 38, 39, 40, thus allowing the banknote to be stacked, smoothly and rapidly, into each stacker 32, 33, 34, 35, 36. In this way, the banknotes can be stored, one by one, in the stacked condition, in each stacker 32, 33, 34, 35, 36, while being pushed downward, from above, by each corresponding stacking wheel 46, 47, 48, 49, 50.

Further, a bundling unit 51 is provided in a lower position in the casing of the second banknote handling apparatus 3. This bundling unit 51 includes a plurality of (e.g., two) reel tapes 52, 53 and a bundling mechanism 54. In this bundling unit 51, one tape can be selectively fed out from either one of the reel tapes 52, 53, for allowing the plurality of banknotes in the stacked condition to be bundled by the bundling mechanism 54.

In addition, a transport device 55 configured for transporting the banknotes is provided in the casing of the second banknote handling apparatus 3. More specifically, this transport device 55 is configured for taking out the banknotes respectively stacked in each stacker 32, 33, 34, 35, 36 and then carrying such banknotes to the bundling unit 51, as well as configured for carrying bundled banknotes (i.e., the banknotes that have been bundled with the tape by the bundling unit 51) to the exterior of the casing. Further, a banknote return unit 56 is provided in an upper part of the casing of the second banknote handling apparatus 3. With this configuration, if the handling operation for the banknotes is ended before the number of the banknotes respectively stacked in each stacker 32, 33, 34, 35, 36 reaches one hundred, such a batch of the banknotes stacked, in a number less than one hundred, in each stacker 32, 33, 34, 35, 36 will be fed to the banknote return unit 56 by the transport device 55. In this embodiment, the transport device 55 can be moved in a direction as denoted by an arrow A in FIG. 3.

As shown in FIG. 4, a control unit 70 configured for controlling each component of the first banknote handling apparatus 2 and second banknote handling apparatus 3 is provided in the casing of the first banknote handling apparatus 2. More specifically, the control unit 70 is connected with the recognition unit 6, transport units 5, 7, 8, 9, 10, diverters 17, 18, 21, 23, 24, 25, 26 and reverse unit 22, respectively provided to the first banknote handling apparatus 2. Further, this control unit 70 is connected with the transport units 31, 37, 38, 39, 40, diverters 41, 42, 43, 44, 45, transport device 55 and bundling unit 51, respectively provided to the second banknote handling apparatus 3. In this case, the recognition result of each banknote recognized by the recognition unit 6 can be transmitted to the control unit 70. In addition, the control unit 70 can serve to control each of the transport units 5, 7, 8, 9, 10, diverters 17, 18, 21, 23, 24, 25, 26 and reverse unit 22, respectively provided to the first banknote handling apparatus 2, as well as control each of the transport units 31, 37, 38, 39, 40, diverters 41, 42, 43, 44, 45, transport device 55 and bundling unit 51, respectively provided to the second banknote handling apparatus 3.

Further, the control unit 70 is provided with a destination designation unit 72 configured for designating each of the banknote handling apparatuses, to which the banknotes of the first country and the banknotes of another country than the first country are to be respectively transported. Further, the control unit 70 is provided with a preferential-country designation unit 74 configured for designating which of the banknotes of the first country and the banknotes of another country than the first country are to be preferentially handled. In this embodiment, the destination designation unit 72 and preferential-country designation unit 74 are provided as one operation unit for allowing the operator to operate the banknote handling machine 1. It is noted that the destination designation unit 72 and preferential-country designation unit 74 will be described later in more detail. Furthermore, the control unit 70 is provided with a memory 76 configured for storing therein the number of the denominations of money, for each country.

While one exemplary construction, which includes the control unit 70, destination designation unit 72, preferential-country designation unit 74 and memory 76, respectively provided in the first banknote handling apparatus 2, has been described with reference to FIG. 4, it is not limited to such an aspect. For instance, all or part of the control unit 70, destination designation unit 72, preferential-country designation unit 74 and memory 76 may be provided to the second banknote handling apparatus 3. Alternatively, the control unit 70 of the banknote handling machine 1 may be connected with a higher-ranking machine via a proper interface. With this configuration, when a command is given to the control unit 70 from the higher-ranking machine, the control unit 70 can control each component of the first banknote handling apparatus 2 and second banknote handling apparatus 3. Further, in this case, the recognition result of each banknote recognized by the recognition unit 6 may be sent to the higher-ranking machine from the control unit 70 via the interface.

Next, the operation of the banknote handling machine 1 constructed as described above will be discussed. In general, this operation can be performed due to the control unit 70 controlling the respective components of the first banknote handling apparatus 2 and second banknote handling apparatus 3, respectively.

In the banknote handling machine 1 of this embodiment, when the banknote recognized by the recognition unit 6 of the first banknote handling apparatus 2 is the banknote of the first country, the control unit 70 controls such that such a banknote is stacked in each stacker 32, 33, 34, 35, 36 of the second banknote handling apparatus 3, for each denomination thereof, while when the banknote recognized by the recognition unit 6 of the first banknote handling apparatus 2 is the banknote of another country than the first country, the control unit 70 controls such that such a banknote is stacked in each stacker 13, 14, 15, 16 of the first banknote handling apparatus 2, for each denomination thereof.

More specifically, the operator first places the banknotes of the plurality of denominations of the plurality of countries, in the mixed state, on the hopper of the take-in unit 4 of the first banknote handling apparatus 2. Then, the banknotes placed on the hopper are fed, one by one, by the feeding mechanism of the take-in unit 4, into the casing, while being recognized by the recognition unit 6. As a result, if the banknote recognized by the recognition unit 6 is the banknote of the first country, such a banknote is fed to the transport unit 31 of the second banknote handling apparatus 3 from the transport unit 10 of the first banknote handling apparatus 2, and then stacked, for each denomination thereof, in each corresponding stacker 32, 33, 34, 35, 36 of the second banknote handling apparatus 3. Meanwhile, if the banknote recognized by the recognition unit 6 is the banknote of another country than the first country, such a banknote is stacked, for each denomination thereof, in each corresponding stacker 13, 14, 15, 16 of the first banknote handling apparatus 2. It is noted that the banknote that cannot be recognized by the recognition unit 6 and/or banknote that is recognized, as the rejected banknote, by the recognition unit 6 will be stacked in each rejected banknote stacker 11, 12.

In this way, when the number of the banknotes stacked in each stacker 32, 33, 34, 35, 36 of the second banknote handling apparatus 3 reaches, for example, one hundred, each batch of such stacked banknotes is fed to the bundling unit 51 by the transport device 55. Then, in the bundling device 51, the tape is selectively fed out from either one of the reel tapes 52, 53, as such the banknotes in a batch form can be bundled with the tape by the bundling mechanism 54. Thereafter, the bundled banknotes prepared by the bundling unit 51 will be dispensed to the exterior of the casing of the second banknote handling apparatus 3 by the transport device 55. Meanwhile, if the handling operation for the banknotes is ended before the number of the banknotes respectively stacked in each stacker 32, 33, 34, 35, 36 reaches one hundred, such a batch of the banknotes stacked, in a number less than one hundred, in each stacker 32, 33, 34, 35, 36 will be fed to the banknote return unit 56 by the transport device 55.

If the banknotes placed on the hopper of the take-in unit 4 of the first banknote handling apparatus 2 are all fed to each stacker 13, 14, 15, 16 of the first banknote handling apparatus 2, or all fed to each stacker 32, 33, 34, 35, 36 of the second banknote handling apparatus 3, the handling operation for the banknotes is ended. Thereafter, if a bundling process for the banknotes of another country than the first country is required, a second handling operation for such banknotes is performed as described below.

Namely, in the second handling operation for the banknotes, the operator first takes out the banknotes from each stacker 13, 14, 15, 16 of the first banknote handling apparatus 2, and then places such banknotes, respectively taken out from each stacker, on the hopper of the take-in unit 4 of the first banknote handling apparatus 2, in the stacked condition. Thereafter, such banknotes placed on the hopper are fed, one by one, into the casing by the feeding mechanism of the take-in unit 4, and then recognized by the recognition unit 6. As a result, if the banknote recognized by the recognition unit 6 is the banknote of a second country, such a banknote is fed to the transport unit 31 of the second banknote handling apparatus 3 from the transport unit 10 of the first banknote handling unit 2, and then stacked, for each denomination thereof, in each corresponding stacker 32, 33, 34, 35, 36 of the second banknote handling apparatus 3. Meanwhile, if the banknote recognized by the recognition unit 6 is the banknote of another country than the first country and second country, such a banknote is stacked, for each denomination thereof, in each corresponding stacker 13, 14, 15, 16 of the first banknote handling apparatus 2. Then, the banknotes of the second country respectively fed to each stacker 32, 33, 34, 35, 36 of the second banknote handling apparatus 3 are bundled by the bundling unit 51. Thereafter, such bundled banknotes prepared by the bundling unit 51 will be dispensed to the exterior of the casing of the second banknote handling apparatus 3 by the transport device 55.

By repetition of the handling operation as described above, the banknotes can be sorted into the banknotes of each country, for each denomination thereof, as well as each batch of such banknotes sorted, for each denomination thereof, can be bundled by the bundling unit 51 of the second banknote handling apparatus 3.

In the above second handling operation for the banknotes, if the banknote recognized by the recognition unit 6 is the banknote of another country than the first country, all of such banknote may be first fed to the transport unit 31 of the second banknote handling apparatus 3 from the transport unit 10 of the first banknote handling apparatus 2, and then stacked in each stacker 32, 33, 34, 35, 36 of the second banknote handling apparatus 3. In this case, the banknotes of the first country can be bundled in the first handling operation, while the banknotes of another country than the first country can be bundled in the second handling operation.

As described above, in the banknote handling machine 1 of this embodiment, the second banknote handling apparatus 3 is connected with the first banknote handling apparatus 2, such that the banknotes respectively recognized by the recognition unit 6 of the first banknote handling apparatus 2 can be fed to the second banknote handling apparatus 3. Then, due to the control unit 70, the banknotes of the first country and the banknotes of another country than the first country can be separated from one another and fed to the first banknote handling apparatus 2 and second banknote handling apparatus 3, respectively. Namely, in the case of handling the banknotes of the plurality of denominations of the plurality of countries, such banknotes are first sorted, for each country, into the banknotes to be transported to the first banknote handling apparatus 2 and the banknotes to be transported to the second banknote handling apparatus 3. Then, in each banknote handling apparatus 2, 3, the banknotes are further sorted, for example, for each denomination thereof, into the banknotes to be respectively stacked in each starker 13, 14, 15, 16, or 32, 33, 34, 35, 36. Therefore, as compared with the banknote handling machine including the plurality of stackers arranged in parallel relative to one another, the number of times the banknotes should be handled can be substantially lessened.

More specifically, when the banknote recognized by the recognition unit 6 of the first banknote handling apparatus 2 is the banknote of the first country, the control unit 70 controls such that such a banknote is stacked in each stacker 32, 33, 34, 35, 36 of the second banknote handling apparatus 3, for each denomination thereof, while when the banknote recognized by the recognition unit 6 of the first banknote handling apparatus 2 is the banknote of another country than the first country, the control unit 70 controls such that such a banknote is stacked in each stacker 13, 14, 15, 16 of the first banknote handling apparatus 2, for each denomination thereof. Namely, in this case, when assigning the banknote handling apparatuses, to which the banknotes of the first country and the banknotes of another country than the first country are to be respectively transported, to the first banknote handling apparatus 2 or second banknote handling apparatus 3, the control unit 70 makes the banknotes of the first country correspond to the second banknote handling apparatus 3, while makes the banknotes of another country than the first country correspond to the first banknote handling apparatus 2.

In this embodiment, the second banknote handling apparatus 3 includes the bundling unit 51 configured for preparing the bundled banknotes by bundling the banknotes stacked in each stacker 32, 33, 34, 35, 36 of the second banknote handling apparatus 3, with bundling paper. Therefore, after the banknotes of the plurality of countries are sorted, for each country, into the banknotes to be transported to the first banknote handling apparatus 2 and the banknotes to be transported to the second banknote handling apparatus 3, the banknotes sorted to be transported to the second banknote handling apparatus 3 can be bundled.

In addition, when the banknote recognized by the recognition unit 6 of the first banknote handling apparatus 2 is the banknote of the first country, the control unit 70 controls such that such a banknote is stacked in each stacker 32, 33, 34, 35, 36 of the second banknote handling apparatus 3, for each denomination thereof, while when the banknote recognized by the recognition unit 6 of the banknote handling machine 2 is the banknote of another country than the first country, the control unit 70 controls such that such a banknote is stacked in each stacker 13, 14, 15, 16 of the first banknote handling apparatus 2, for each denomination thereof, and then the control unit 70 controls the bundling unit 51 to bundle the banknotes of the first country stacked in each stacker 32, 33, 34, 35, 36 of the second banknote handling apparatus 3, thereby allowing such bundled banknotes of the first country to be taken out from the second banknote handling apparatus 3. Thereafter, in the second handling operation following the first handling operation, when the banknote recognized by the recognition unit 6 of the first banknote handling apparatus 2 is the banknote of another country than the first country, the control unit 70 controls such that such a banknote is stacked in each stacker 32, 33, 34, 35, 36 of the second banknote handling apparatus 3, for each denomination thereof, and then controls the bundling unit 51 to bundle the banknotes of another country than the first country stacked in each stacker 32, 33, 34, 35, 36 of the second banknote handling apparatus 3, thereby to allow such bundled banknotes of another country than the first country to be taken out from the second banknote handling apparatus 3. In this way, the banknotes of the first country can be bundled in the first handling operation, and then the banknotes of another country than the first country can be bundled in the second handling operation.

It should be noted that the banknote handling machine 1 of this embodiment is not limited to such an aspect as described above, and that various alterations and modifications can be made thereto. For instance, each of the banknote handling apparatuses, to which the banknotes of the first country and the banknotes of another country than the first country are to be respectively transported, may be designated, in advance, by the operator, via the destination designation unit 72. In this case; the control unit 70 controls such that the banknotes of the first country and the banknotes of another country than the first country are respectively stacked in each stacker of the banknote handling apparatuses designated by the destination designation unit 72, based on the recognition result of each banknote recognized by the recognition unit 6 of the first banknote handling apparatus 2.

More specifically, in the case the operator assigns the banknotes of the first country to the first banknote handling, apparatus 2, while assigning the banknotes of another country than the first country to the second banknote handling apparatus 3, via the destination designation unit 72, when the banknote recognized by the recognition unit 6 of the first banknote handling apparatus 2 is the banknote of the first country, the control unit 70 controls such that such a banknote is stacked in each stacker 13, 14, 15, 16 of the first banknote handling apparatus 2. Meanwhile, in the above case, when the banknote recognized by the recognition unit 6 of the first banknote handling apparatus 2 is the banknote of another country than the first country, the control unit 70 controls such that such a banknote is stacked in each stacker 32, 33, 34, 35, 36 of the second banknote handling apparatus 3.

Further, the operator may designate, by the destination designation unit 72, each of the banknote handling apparatuses, to which the banknotes of the first country and the banknotes of another country than the first country are to be respectively transported, as well as designate, via the preferential-country designation unit 74, which of the banknotes of the first country and the banknotes of another country than the first country are to be preferentially handled. In this case, for the banknotes of the first country or another country than the first country, designated by the preferential-country designation unit 74, if the number of the denominations of money stored in the memory 76 is greater than the number of the stackers provided to one banknote handling apparatus designated by the destination designation unit 72, the control unit 70 can assign the stacker of the other banknote handling machine to stack therein the banknotes the denomination of which is not assigned to the stacker of the one banknote handling apparatus designated by the destination designation unit 72.

For instance, when the operator assigns, via the destination designation unit 72, the banknotes of the first country to the second banknote handling apparatus 3, while assigning the banknotes of another country than the first country to the first banknote handling apparatus 2, as well as designates, by the preferential-country designation unit 74, the banknotes of the first country to be preferentially handled, and when the number of the denominations of the banknotes of the first country is six, such a number (i.e., six) of the denominations of the banknotes of the first country exceeds the number (i.e., five) of the stackers 32, 33, 34, 35, 36 respectively provided to the second banknote handling apparatus 3. Therefore, one of such six denominations of the banknotes of the first country cannot be assigned to any of the five stackers 32, 33, 34, 35, 36 of the second banknote handling apparatus 3. In this case, one of the four stackers 13, 14, 15, 16 (e.g., the stacker 13) provided to the first banknote handling apparatus 2 may be used as the stacker for stacking therein the banknotes of such one denomination that is not assigned to any of the stackers 32, 33, 34, 35, 36 of the second banknote handling apparatus 3. Thus, the six denominations of the banknotes of the first country can be assigned to the six stackers (i.e., the stacker 13 of the first banknote handling apparatus 2 and the stackers 32, 33, 34, 35, 36 of the second banknote handling apparatus 3).

Further, the banknote handling machine 1 may be used for handling the banknotes of three or more countries. For instance, when the banknote recognized by the recognition unit 6 of the first banknote handling apparatus 2 is the banknote of the first country, the control unit 70 controls such that such a banknote is stacked in each stacker 32, 33, 34, 35, 36 of the second banknote handling apparatus 3, for each denomination thereof, while when the banknote recognized by the recognition unit 6 of the first banknote handling apparatus 2 is the banknote of the second country, the control unit 70 controls such that such a banknote is stacked in each of the three stackers 13, 14, 15, for each denomination thereof. Further, in this case, when the banknote recognized by the recognition unit 6 of the first banknote handling apparatus 2 is not the banknote of the first country or the banknote of the second country, the control unit 70 controls such that such a banknote is stacked in the stacker 16 to be used as a certain one stacker, in the mixed state. However, in the case the banknote handling machine 1 is used for handling the banknote of three or more countries, it should be noted that the manner of controlling by the control unit 70 is not limited to such an aspect as described above. Namely, any other suitable control manner may be employed in this case.

Further, it should be noted that the destination designation unit 72 and/or preferential-country designation unit 74 is not limited to such an aspect of the operation unit as provided to be operated by the operator. For instance, by signal transmitted from the higher-ranking machine to the control unit 70, each of the banknote handling apparatuses, to which the banknotes of the first country and the banknotes of another country than the first country are to be respectively transported, may be designated, and/or which of the banknotes of the first country and the banknotes of another country than the first country are to be preferentially handled may be designated. Additionally, during the installation of the banknote handling machine 1, each of the banknote handling apparatuses, to which the banknotes of the first country and the banknotes of another country than the first country are to be respectively transported, may be designated in advance, and/or which of the banknotes of the first country and the banknotes of another country than the first country are to be preferentially handled may be designated in advance. Further, according to the handling condition of the banknotes, the control unit 70 may automatically designate each of the banknote handling apparatuses, to which the banknotes of the first country and the banknotes of another country than the first country are to be respectively transported, and/or may automatically designate which of the banknotes of the first country and the banknotes of another country than the first country are to be preferentially handled.

Further, when the banknote recognized by the recognition unit 6 of the first banknote handling apparatus 2 is the banknote of the first country and the fit banknote, the control unit 70 may control such that such a banknote is stacked in each stacker 32, 33, 34, 35 of the second banknote handling apparatus 3, for each denomination thereof, while when the banknote recognized by the recognition unit 6 is the banknote of the first country and the unfit banknote, the control unit 70 may control such that such a banknote is stacked in the stacker 36 of the second banknote handling apparatus 3, in the mixed state. Meanwhile, when the banknote recognized by the recognition unit 6 is the banknote of another country than the first country and the fit banknote, the control unit 70 may control such that such a banknote is stacked in each stacker 13, 14, 15 of the first banknote handling apparatus 2, for each denomination thereof, while when the banknote recognized by the recognition unit 6 is the banknote of another country than the first country and the unfit banknote, the control unit 70 may control such that such a banknote is stacked in the stacker 16 of the first banknote handling apparatus 2. Alternatively, the stackers for stacking therein the fit banknotes may be separated from the stacker (or stackers) for stacking therein the unfit banknotes, for only the banknotes of each country designated by the operator, instead of being separated from the latter stacker (or stackers), for the banknotes of all related countries.

Further, the operator may select, via the operation unit provided to the banknote handling machine 1, the country issuing the banknotes, for which the stackers for stacking therein the fit banknotes are separated from the stacker (or stackers) for stacking therein the unfit banknotes. For instance, the operator may select, via the operation unit, only the first country, as the country that issues the banknotes, for which the stackers for stacking therein the fit banknotes are separated from the stacker (or stackers) for stacking therein the unfit banknotes. Otherwise, the operator may select, via the operation unit, only another country than the first country, as the country issuing the banknotes, for which the stackers for stacking therein the fit banknotes are separated from the stacker (or stackers) for stacking therein the unfit banknotes. Furthermore, the operator may select, via the operation unit, all related countries, as the country issuing the banknotes, for which the stackers for stacking therein the fit banknotes are separated from the stacker (or stackers) for stacking therein the unfit banknotes. Additionally, by the signal transmitted from the higher-ranking machine to the control unit 70, the country issuing the banknotes, for which the stackers for stacking therein the fit banknotes are separated from the stacker (or stackers) for stacking therein the unfit banknotes, may be selected.

In addition, the second banknote handling apparatus 3 may not include the bundling unit 51. In this case, similar to each stacker 13, 14, 15, 16 of the first banknote handling apparatus 2, each stacker 32, 33, 34, 35, 36 of the second banknote handling apparatus 3 is configured for stacking therein the banknotes, while allowing the operator to take out the banknotes, by hand, therefrom. Further, the second banknote handling apparatus 3 may be configured in substantially the same manner as the first banknote handling apparatus 2. Alternatively, in the case of the second banknote handling apparatus 3 not including the bundling unit 51, each stacker 32, 33, 34, 35, 36 may be of a storage-unit type. Herein, the stacker of the “storage-unit type” means a storage unit configured not to allow the operator to take out the banknotes, directly, by hand, therefrom.

Alternatively, a plurality of bundling units 51 may be provided to the second banknote handling apparatus 3. In this case, if it is necessary to simultaneously bundle the banknotes of the plurality of denominations with the bundling paper, the banknotes of the plurality of denominations can be bundled simultaneously by such a plurality of bundling units 51, thereby substantially reducing the time required for handling the banknotes.

Further, a plurality of second banknote handling apparatuses 3 may be provided to a single first banknote handling apparatus 2. In this case, the plurality of second banknote handling apparatuses 3 may be connected, in series, to the first banknote handling apparatus 2, or otherwise may be connected, in parallel, with the first banknote handling apparatus 2. In the latter case, the banknotes can be fed to each of the second banknote handling apparatuses 3 from the first banknote handling apparatus 2, respectively. In the case a plurality of second banknote handling apparatuses 3 are provided, if the banknotes of the plurality of countries are bundled, it is possible to bundle the banknotes of the plurality of countries simultaneously by the plurality of banknotes handling apparatuses 3, thereby significantly reducing the time required for handling the banknotes.

1. A banknote handling machine configured for handling banknotes of a plurality of denominations of a plurality of countries, such banknotes including the banknotes of a first country and the banknotes of another country than the first country, and the banknote handling machine comprising:
a first banknote handling apparatus including a take-in unit configured for taking in the banknotes, a recognition unit configured for recognizing the banknotes taken in by the take-in unit, and a stacker configured for stacking therein the banknotes respectively recognized by the recognition unit;
a second banknote handling apparatus connected with the first banknote handling apparatus, configured for receiving the banknotes recognized by the recognition unit of the first banknote handling apparatus and including another stacker configured for stacking therein the banknotes fed from the first banknote handling apparatus; and
a control unit configured for controlling the first banknote handling apparatus and second banknote handling apparatus to assign the banknote handling apparatuses, to which the banknotes of the first country and the banknotes of another country than the first country are to be respectively transported, to the first banknote handling apparatus or second banknote handling apparatus.

2. The banknote handling machine according to claim 1,
wherein when the banknote recognized by the recognition unit of the first banknote handling apparatus is the banknote of the first country, the control unit controls such that such a banknote is stacked in the stacker of the second banknote handling apparatus, while when the banknote recognized by the recognition unit of the first banknote handling apparatus is the banknote of another country than the first country, the control unit controls such that such a banknote is stacked in the stacker of the first banknote handling apparatus.

3. The banknote handling machine according, to claim 1,
wherein a plurality of stackers are provided to the first banknote handling apparatus and configured such that the banknotes are stacked in each stacker, for each denomination thereof.

4. The banknote handling machine according to claim 1,
wherein a plurality of stackers are provided to the second banknote handling apparatus and configured such that the banknotes are stacked in each stacker, for each denomination thereof.

5. The banknote handling machine according to claim 1,
wherein the second banknote handling apparatus includes a bundling unit configured for bundling the banknotes stacked in the stacker of the second banknote handling apparatus, with a bundling paper, so as to prepare bundled banknotes.

6. The banknote handling machine according to claim 5,
wherein, in a first handling operation, when the banknote recognized by the recognition unit of the first banknote handling apparatus is the banknote of the first country, the control unit controls such that such a banknote is stacked in the stacker of the second banknote handling apparatus, while when the banknote recognized by the recognition unit of the first banknote handling apparatus is the banknote of another country than the first country, the control unit controls such that such a banknote is stacked in the stacker of the first banknote handling apparatus, and then controls the bundling unit to bundle the banknotes of the first country stacked in the stacker of the second banknote handling apparatus, with the bundling paper, thereby allowing such bundled banknotes of the first country to be taken out from the second banknote handling apparatus, and in a second handling operation following the first handling operation, when the banknote recognized by the recognition unit of the first banknote handling apparatus is the banknote of another country than the first country, the control unit controls such that such a banknote is stacked in the stacker of the second banknote handling apparatus, and then controls the bundling unit to bundle the banknotes of another country than the first country stacked in the stacker of the second banknote handling apparatus, with the bundling paper, thereby allowing such bundled banknotes of another country than the first country to be taken out from the second banknote handling apparatus.

7. The banknote handling machine according to claim 1, further comprising:
a destination designation unit configured for designating, in advance, each of the banknote handling apparatuses, to which the banknotes of the first country and the banknotes of another country than the first country are to be respectively transported,
wherein the control unit controls such that the banknotes of the first country and banknotes of another country than the first country are respectively stacked in the stacker of each banknote handling apparatus designated by the destination designation unit, based on the recognition result of the banknotes respectively recognized by the recognition unit of the first banknote handling apparatus.

8. The banknote handling machine according to claim 1, further comprising:
a destination designation unit configured for designating, in advance, each of the banknote handling apparatuses, to which the banknotes of the first country and the banknotes of another country than the first country are to be respectively transported,
a preferential-country designation unit configured for designating, in advance, which of the banknotes of the first country and the banknotes of another country than the first country are to be preferentially handled; and
a memory configured for storing therein the number of the denominations of money, for each country,
wherein when the number of the denominations of money stored in the memory is greater than the number of the stackers of one banknote handling apparatus designated by the destination designation unit, in regard to the banknotes of the first country or banknotes of another country than the first country designated by the preferential-country designation unit, the control unit assigns the stacker of the other banknote handling apparatus to stack therein the banknotes, the denomination of which is not assigned to the stacker of the one banknote handling apparatus designated by the destination designation unit.

9. The banknote handling machine according to claim 1,
wherein the banknote handling machine is configured for handling the banknotes of three or more countries,
a plurality of stackers are provided to the first banknote handling apparatus and second banknote handling apparatus, respectively, and
when the banknote recognized by the recognition unit of the first banknote handling apparatus is the banknote of the first country, the control unit controls such that such a banknote is stacked in each stacker of the second banknote handling apparatus, for each denomination thereof, while when the banknote recognized by the recognition unit of the first banknote handling apparatus is not the banknote of the first country or the banknote of a second country, the control unit controls such that such a banknote is stacked in a certain one of the stackers of the first banknote handling apparatus, in a mixed state, and while when the banknote recognized by the recognition unit of the first banknote handling apparatus is the banknote of the second country, the control unit controls such that such a banknote is stacked in each stacker, except for the certain one stacker, of the first banknote handling apparatus, for each denomination thereof.
